(19) United States
(12) Patent Application Publication
(10) Pub. No.: US 2019/0297848 A1
(43) Pub. Date: Oct. 3, 2019

(54) DURABLE MATERIAL FOR USE IN PET TOYS AND OTHER OBJECTS AND METHOD FOR MANUFACTURING SAID MATERIAL

(71) Applicant: Caitec Corporation, Halethorpe, MD (US)

(72) Inventor: Terry Taishan GAO, Halethorpe, MD (US)

(21) Appl. No.: 16/373,297

(22) Filed: Apr. 2, 2019

Related U.S. Application Data
(60) Provisional application No. 62/651,293, filed on Apr. 2, 2018.

(51) Int. Cl. A01K 15/02

(52) U.S. Cl. CPC A01K 15/025

(57) ABSTRACT

A pet toy formed of a first material that includes a mesh material with one or more openings and at least one integrally formed molded projection extending outward from the mesh material, and a second material overmolded onto the first material, the second material having greater rigidity than the first material, wherein the second material is formed over all outer edges of the first material such that the outer edges of the first material are fully covered by the second material, whereby the first material and the second material cooperate to define an inner chamber of the pet toy

### CROSS REFERENCE TO RELATED APPLICATION

The present application claims priority to U.S. Provisional Application No. 62/651,293, filed Apr. 2, 2018, the entire contents of which is incorporated herein for all purposes by this reference.

### TECHNICAL FIELD

This application relates to material that can be used to manufacture pet toys including, without limitation, dog toys. More particularly, the present invention pertains to a material that is stronger, more durable and more resilient than conventional fabric or sheet-material. More particularly still, the present invention pertains to a method for manufacturing material that includes shaped protrusions or extensions that are stronger, more durable and less likely to break or tear off than those created using conventional manufacturing methods.

### BACKGROUND

The present disclosure provides a material for a pet toy that includes shaped protrusions or extensions that are stronger, more durable and less likely to break or tear off than those provided conventional pet toy materials, and a method for manufacturing the same.

Currently, many conventional toys for dogs and other pets employ some form of projection(s) that extend outward from a substantially smooth surface such as, for example, the outer surface of a ball or throw toy. Such projections can be pleasing to pets during play, while also frequently promoting dental health when chewed or gnawed by a pet. The projections can be selectively shaped to form ridges or surfaces that can abrade or clean pet teeth and gums during play.

Such projections can have any number of different shapes, sizes, configurations and/or patterns, and are frequently designed for both functional and fanciful considerations. For example, such projections can often approximate the shape of bones or other dog-related objects when used on dog toys. Alternatively, the projections can have other shapes when used on toys for other animals. Such shapes can be appealing to pets and pet owners, while also providing dental or other health benefits to such pets.

Conventional pet toy projections are typically manufactured or created separately from a toy. In many cases, such projections are generally attached to an outer surface of a toy using an over-molding process, adhesive or other fastening means. However, when subjected to forces applied by a playing, chewing or gnawing pet, such conventional projections can frequently break apart or otherwise become separated from the toy. When that occurs, the separated projections can become choking hazards for a pet or cause a blockage in the intestinal tact, and the toy can lose its appeal and/or other beneficial characteristics.

Thus, there is a need for a material that can be used for the manufacture of various objects such as pet toys including, without limitation, chewable dog or other animal toys. The material should be stronger, more durable and/or more resilient than conventional fabric. Further, in a preferred embodiment, the material should include integrally formed projections that will not separate or break off from a toy during normal or conventional use.

However, such technologies do not exist. Accordingly, this disclosure enables such technologies.

### SUMMARY

To achieve the foregoing objects, and in accordance with the purpose of the invention as embodied and broadly described herein, there is provided a material for manufacturing pet toys that includes a mesh material comprising one or more openings, and at least one integrally formed molded projection extending outward from the mesh.

According to an embodiment of the invention, the mesh material is a cotton duck fabric having a weight of at least 10 oz and a thickness of 0.35 mm to 0.60 mm.

According to another embodiment of the invention, the mesh material is a nylon fabric that is a 420 denier fabric with a thickness of at least 0.20 mm.

According to another embodiment of the invention, there is a pet toy that includes a first material formed of a mesh material having one or more openings and at least one integrally formed molded projection extending outward from the mesh material, and a second material attached to the first material, the second material having greater rigidity than the first material, wherein the second material is overmolded onto at least a portion of the first material.

According to another embodiment of the invention, the second material of the pet toy is formed over all outer edges of the first material such that the outer edges of the first material are fully covered by the second material.

According to another embodiment of the invention, the first material of the pet toy is at least partially collapsible.

According to another embodiment of the invention, the first material of the pet toy comprises a coarse outer surface surrounding the at least one integrally formed projection.

According to another embodiment of the invention, the first material of the pet toy comprises a substantially smooth outer surface surrounding the at least one integrally formed projection.

According to another embodiment of the invention, the first and second materials cooperate to define an inner chamber of the pet toy.

According to another embodiment of the invention, a sound emitting device is disposed or formed inside the inner chamber of the pet toy.

According to yet another embodiment of the invention, there is provided a method of manufacturing a pet toy, the method including forming a first material that includes a mesh material comprising one or more openings and at least one integrally formed molded projection extending outward from the mesh material, and overmolding a second material onto at least a portion of the first material, the second material having greater rigidity than the first material, wherein the second material is formed over all outer edges of the first material such that the outer edges of the first material are fully covered by the second material.

### BRIEF DESCRIPTION OF THE DRAWINGS

The accompanying drawings constitute a part of this specification and illustrate an embodiment of the present disclosure and together with the specification, explain the present disclosure.

FIG. 1 shows a side perspective, partial cut-away view of an exemplary pet toy product manufactured from the material of the present invention.

FIG. 2 shows a side view of an exemplary pet toy product manufactured from the material of the present invention.

FIG. 3 shows an alternative side view of the pet toy product shown in FIG. 2.

FIG. 4 shows a side perspective view of a partially disassembled exemplary pet toy manufactured from the material of the present invention.

FIG. 5(A) shows a top view of an embodiment of a pet toy having a propeller shape that is manufactured from the material of the present invention, and FIG. 5(B) shows a side view of the pet toy shown in FIG. 5(A).

FIG. 6(A) shows a top view of an embodiment of a pet toy having a ring shape that is manufactured from the material of the present invention, and FIG. 6(B) shows a side view of the pet toy shown in FIG. 6(A).

FIG. 7(A) shows a top view of an embodiment of a pet toy having a boomerang shape that is manufactured from the material of the present invention, and FIG. 7(B) shows a side view of the pet toy shown in FIG. 7(A).

### DETAILED DESCRIPTION OF THE PREFERRED EMBODIMENTS

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

As used herein, various singular forms “a,” “an” and “the” are intended to include various plural forms as well, unless context clearly indicates otherwise. For example, a term “a” or “an” shall mean “one or more,” even though a phrase “one or more” is also used herein. Use of the optional plural “(s),” “(es),” or “(ies)” means that one or more of the indicated feature is present.

As used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, features described with respect to certain embodiments may be combined in or with various other embodiments in any permutational or combinatory manner. Different aspects or elements of example embodiments, as disclosed herein, may be combined in a similar manner.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

The term “fabric” is used to mean a cloth made from natural fiber, synthetic fiber, or a combination of both.

The term “geometrically-shaped” as used herein includes circular, polygon, rectangular, square, and triangular shapes.

The present invention comprises a material that can be used for the manufacture of various objects such as pet toys including, without limitation, chewable dog toys. The material is stronger, more durable, and more resilient than conventional fabric or synthetic sheet material. In a preferred embodiment, the material should be capable of generating or emitting audible sounds or noises, particularly when physically contacted or manipulated by a pet (such as a dog) or other external force acting on the material.

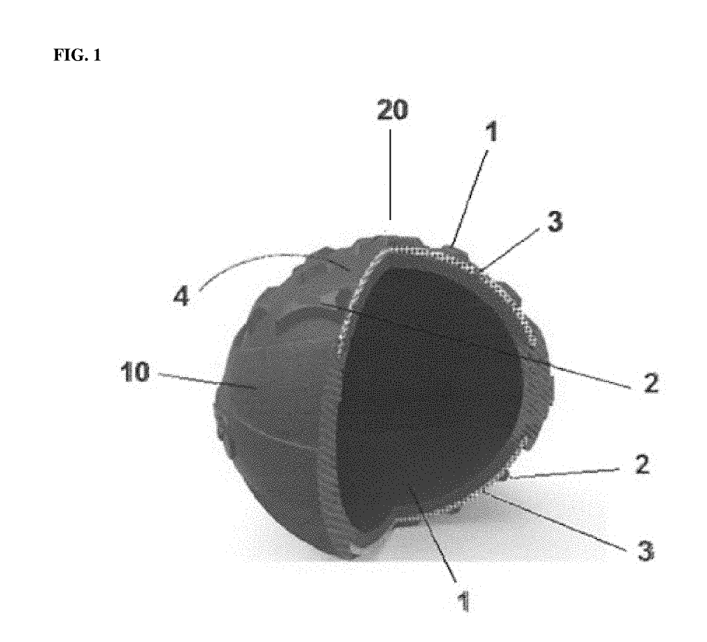

FIG. 1 depicts a side perspective, partial cut-away view of a pet toy 20 manufactured using material 1 of the present invention (colored blue in FIG. 1). It is understood that the pet toy described herein can be any type of toy, such as a child toy. In a preferred embodiment, the material 1 of the present invention comprises a resilient mesh 3 defining a plurality of spaced-apart openings or apertures, and having desired physical characteristics such as size, weight and strength to match particular desired applications. The mesh 3 can comprise a synthetic fabric or other flexible material. Although other materials can be utilized without departing from the scope of the present invention, in a preferred embodiment the mesh 3 comprises synthetic or natural material (including, without limitation, cotton). Alternatively, the mesh 3 can also comprise a relatively course fabric or canvas material.

According to an embodiment of the invention, the mesh 3 may comprise a heavy weight tight woven fabric to ensure strength and durability, such as a cotton duck or a nylon denier weave fabric. The mesh 3 is preferably formed with a plurality of spaced-apart openings or apertures (e.g., die cut holes) that provide for the molded shape of the projections 2 (e.g., shape of a bone) on the outside surface of the material 1. It is important that the mesh 3 be of a sufficient thickness to ensure that the material will maintain its original die cut shape and not become damaged and/or distorted during the injection molding process due to high pressure and heat when molten foam and/or thermoplastic resin passes through the die cut holes formed in the mesh 3.

The mesh 3 may comprise a 100% cotton duck fabric (also referred to as duck canvas or duck fabric) because of the high heat resistance characteristics of such fabric. Preferably, the cotton duck has a minimum cotton fabric weight of 10 oz and a thickness of between 0.35 mm to 0.60 mm. Alternatively, the mesh 3 may comprise a 100% nylon fabric, which also has excellent heat resistance characteristics. Preferably, the nylon fabric is a 420 D (420 denier) nylon fabric having a minimum thickness of 0.2 mm. Polyester fabric, which generally has lower heat resistance qualities than cotton duck and nylon, may not be preferable because the material may get damaged and/or distorted during the injection molding process due to high pressure and heat when molten foam and/or thermoplastic resin pass through die cut holes formed in the polyester fabric mesh 3.

During the manufacturing process, the mesh material 3 is positioned within a mold, and molten or flowable thermoplastic polymer is then injected into then mold. A portion of the injection molded polymer passes through the openings or apertures (e.g., die cut holes) of the mesh material and into at least one recess or cavity in the mold. The recesses or cavities have predetermined shape(s), pattern(s) and dimensions. When the polymer is removed from the mold, the portion of thermoplastic polymer that has passed through the opening of the mesh 3 material and into the cavities or recesses forms positive projections extending or protruding from a surface of the material 1. The projections 2 can embody any number of different shapes, sizes, configurations and/or patterns, and are frequently designed for both functional and fanciful considerations. For example, such projections 2 can often approximate the shape of bones or other dog-related objects when used on dog toys. Such shapes can be appealing to pets and pet owners, while also providing dental or other health benefits to pets. Although outer surface 4 of material 1 can be substantially smooth, in a preferred embodiment some amount of mesh material 3 can extend outward on the outer surface 4, thereby giving the outer surface a coarse or abrasive texture that can be appealing to pets.

Material 1 can be used to manufacture a toy or other object employing some form of noise-maker for generating audible sounds or noises that are generally pleasing to pets, as well as other animals and their companions. For example, a whistle, “squeaker” or other similar noise generating device may be mounted on or inside a toy, wherein the noise generating device emits an audible squeak or other sound when the toy is at least partially compressed and air or other fluid is expelled through the device. The toy may be designed with an inner chamber or hollow section that is at least partially collapsible so that the toy can mimic or act like a bellows—the toy emits a stream of air when squeezed together, such as when a dog or other pet bites down on or otherwise compresses the toy. This stream of air is directed through the noise generating device to emit an audible sound that is pleasing to the dog (or other pet) when the dog bites down on, compresses or squeezes the toy.

Still referring to FIG. 1, material 1 of the present invention can be combined with one or more other plastics, rubbers, polymers and/or other conventional materials, such as molded plastic section 10 (colored red in FIG. 1), when constructing a pet toy, particularly a noise-emitting squeeze toy. Plastic section 10 can be constructed of a more rigid material, and/or include hardening or reinforcing additives, than material 1. As such, a toy made using the material 1 of present invention can be at least partially collapsible where material 1 is positioned, and substantially more rigid or resistant to deflection where material 10 is positioned.

According to an embodiment of the invention, the molded plastic material 10 of the pet toy 20 may be overmolded onto the material 1. More specifically, the molded plastic section 10 may be formed by overmolding molten plastic, such as plastic foam and/or thermoplastic resin, over at least a portion of material 1. Preferably, the molded plastic section 10 will be formed over all of the outer edges and on top of all of the edges of the material 1 so that the edges of the material 1 are fully covered by the molded plastic section 10. This will provide further security and protection so that the material 1 cannot easily be pulled up or torn off, such as by a dog, for example, while chewing the toy.

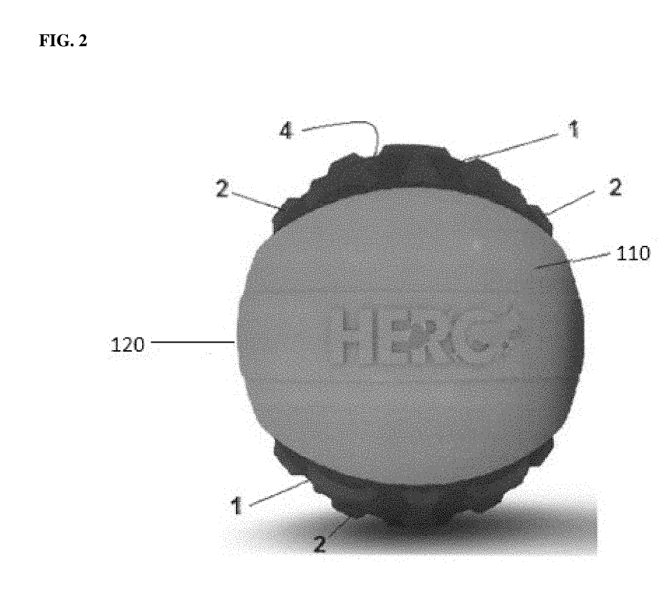

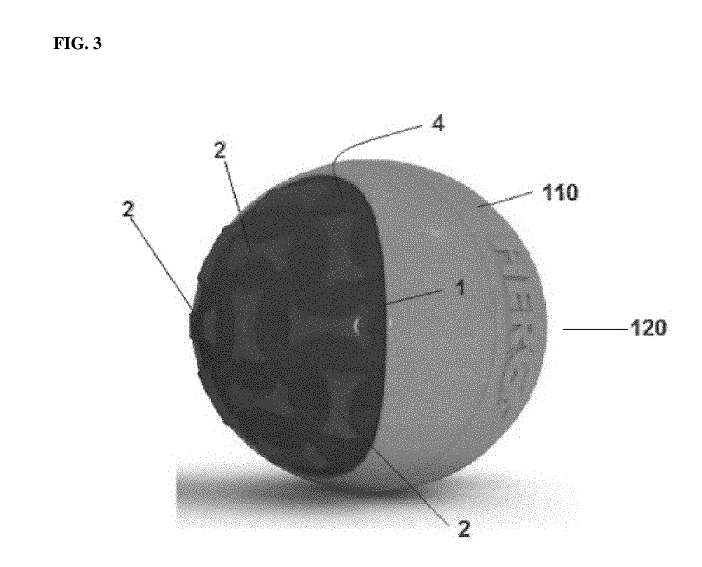

FIG. 2 shows a side view of a pet toy 120 partially manufactured using the material 1 of the present invention, while FIG. 3 depicts an alternative side view of the pet toy 120 manufactured using material 1 of the present invention. Referring to FIGS. 2 and 3, pet toy 120 includes material 1 of the present invention (colored purple in FIGS. 2 and 3). Positive projections 2 extend or protrude from the outer surface of the material 1. The projections may be formed according to the manufacturing process described above. Although outer surface 4 of material 1 can be substantially smooth, in a preferred embodiment some amount of mesh material can extend outward on or from the outer surface 4, thereby giving the outer surface a coarse or abrasive texture that can be appealing to pets. Plastic section 110 (colored green in FIGS. 2 and 3) can be constructed of a more rigid material compared to material 1. As such, pet toy 120 made using the material 1 of present invention can be at least partially collapsible where material 1 is positioned (purple portion), and substantially more rigid or resistant to deflection where material 110 is positioned (green section).

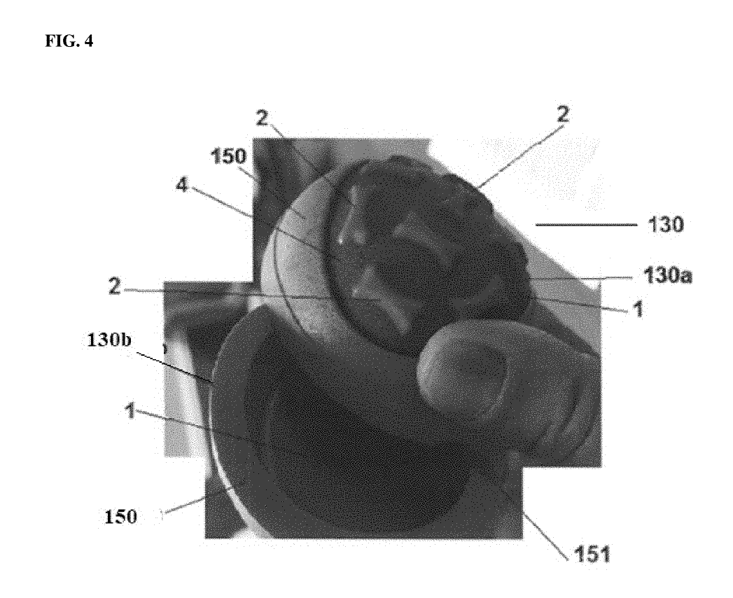

FIG. 4 shows a side perspective view of a partially disassembled pet toy 130 manufactured from the material of the present invention. Referring to FIG. 4, pet toy 130 includes material 1 of the present invention (colored blue in FIG. 4). Positive projections 2 extend or protrude from the outer surface of the material 1. Although outer surface 4 of material 1 can be substantially smooth, in a preferred embodiment some amount of mesh material can extend outward on or from the outer surface 4, thereby giving the outer surface 4 a coarse or abrasive texture that can be appealing to certain pets.

Still referring to FIG. 4, plastic material 150 (colored red in FIG. 4) can comprise a more rigid material compared to material 1. As depicted in FIG. 4, pet toy 130 is shown split into two segments 130a and 130b; it is to be observed that the segments 130a and 130b can be bonded or otherwise joined using conventional means well known to those having skill in the art in order to form a substantially spherical toy. When desired, plastic material 150 can include preformed recess or channel 151. The preformed recess or channel 151 can form an aperture for receiving a “squeaker” or other sound-emitting device. As such, toy 130 made using the material 1 of present invention can be at least partially collapsible where material 1 is positioned (blue portion), and substantially more rigid or resistant to deflection where plastic material 150 is positioned (red section).

Although pet toy 120 is shown having a ball shape in FIGS. 1-4, it is understood that pet toy 120 may be made into a variety of different shapes using the manufacturing process of the present invention and is not limited to any particular shape.

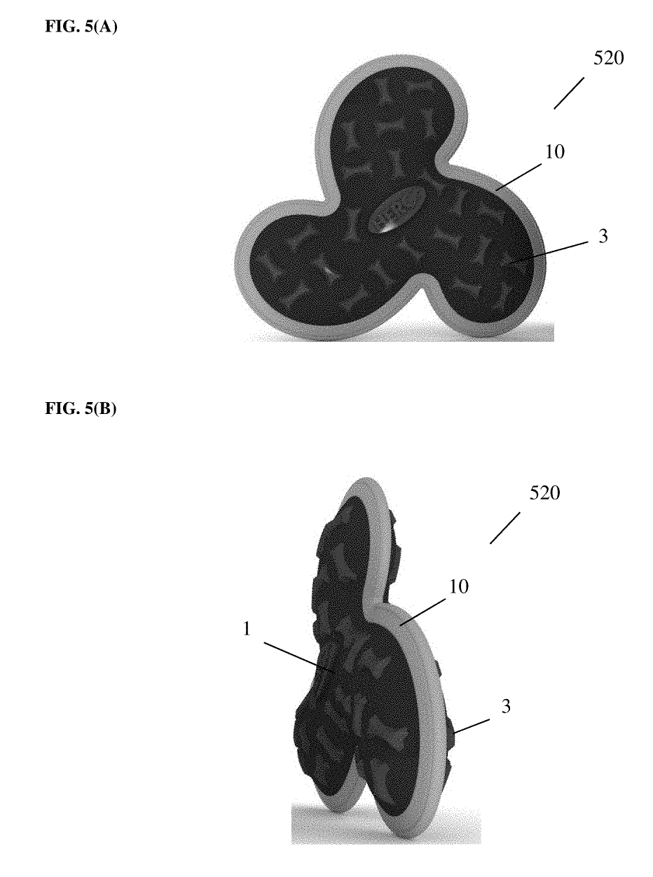

For example, FIGS. 5(A) and 5(B) show an embodiment of a pet toy 520 having a propeller shape that is manufactured using the material 1 (colored purple) of the present invention. FIG. 5(A) shows a top view of pet toy 520 and FIG. 5(B) shows a side view of pet toy 520. As shown, positive projections 2 extend or protrude from the outer surface of the material 1. The material 1 is combined with a molded plastic section 10 (colored green), such as described above. The pet toy 520 is at least partially collapsible where material 1 is positioned, and substantially more rigid or where material 10 is positioned. Pet toy 520 may include a sound emitting device, such as a “squeaker” mounted therein. The “squeaker” may squeak when the pet toy 520 is at least partially compressed and air or other fluid is expelled through the device.

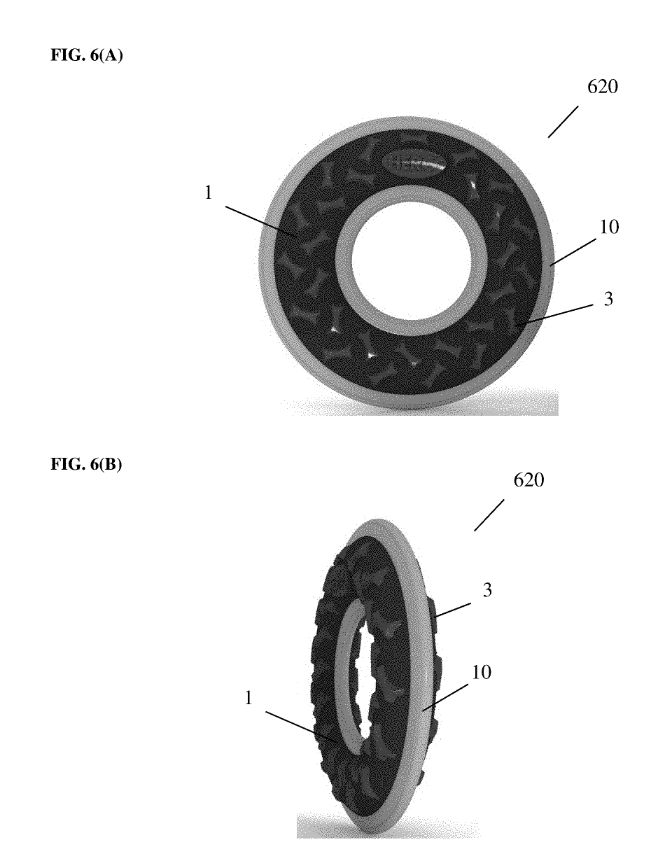

For example, FIGS. 6(A) and 6(B) show an embodiment of a pet toy 620 having a ring shape that is manufactured using the material 1 (colored purple) of the present invention. FIG. 6(A) shows a top view of pet toy 620 and FIG. 6(B) shows a side view of pet toy 620. As shown, positive projections 2 extend or protrude from the outer surface of the material 1. The material 1 is combined with a molded plastic section 10 (colored green), such as described above. Pet toy 620 is at least partially collapsible where material 1 is positioned, and substantially more rigid or where material 10 is positioned. Pet toy 620 may include a sound emitting device, such as a “squeaker” mounted therein. The “squeaker” may squeak when the pet toy 620 is at least partially compressed and air or other fluid is expelled through the device.

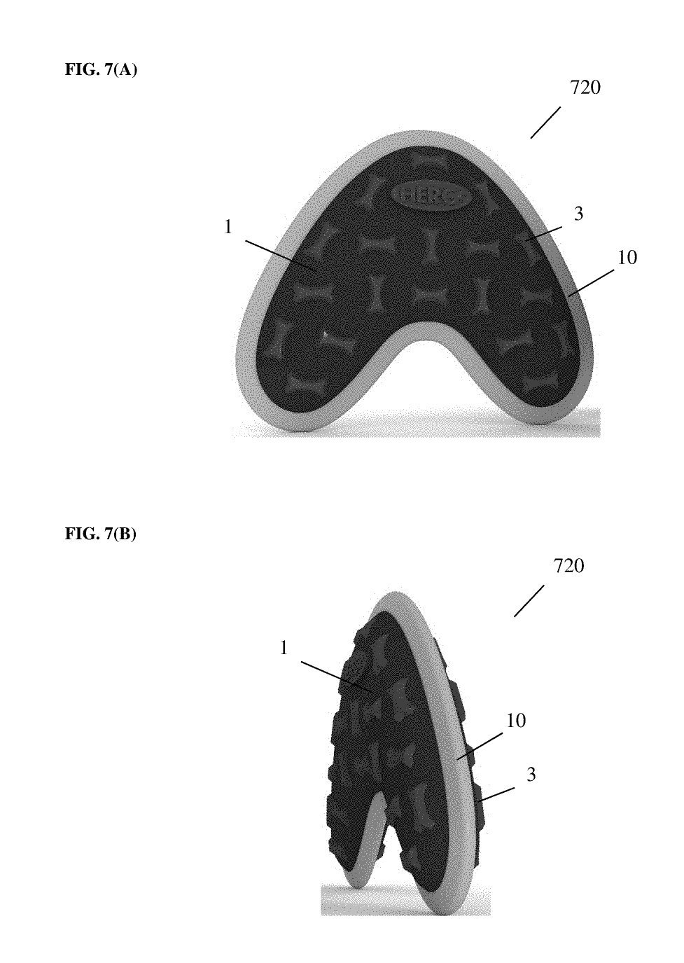

For example, FIGS. 7(A) and 7(B) show an embodiment of a pet toy 720 having a boomerang shape that is manufactured using the material 1 (colored purple) of the present invention. FIG. 7(A) shows a top view of pet toy 720 and FIG. 7(B) shows a side view of pet toy 720. As shown, positive projections 2 extend or protrude from the outer surface of the material 1. The material 1 is combined with a molded plastic section 10 (colored green), such as described above. Pet toy 720 is at least partially collapsible where material 1 is positioned, and substantially more rigid or where material 10 is positioned. Pet toy 720 may include a sound emitting device, such as a “squeaker” mounted therein. The “squeaker” may squeak when the pet toy 720 is at least partially compressed and air or other fluid is expelled through the device.

The above-described invention has a number of particular features that should preferably be employed in combination, although each is useful separately without departure from the scope of the invention. While the preferred embodiments of the present invention are shown and described herein, it will be understood that the invention may be embodied otherwise than herein specifically illustrated or described, and that certain changes in form and arrangement of parts and the specific manner of practicing the invention may be made within the underlying idea or principles of the invention.

The above-described invention has a number of particular features that should preferably be employed in combination, although each is useful separately without departure from the scope of the invention. While the preferred embodiments of the present invention are shown and described herein, it will be understood that the invention may be embodied otherwise than herein specifically illustrated or described, and that certain changes in form and arrangement of parts and the specific manner of practicing the invention may be made within the underlying idea or principles of the invention.

Although the invention is described herein with reference to specific embodiments, it is understood that various modifications and changes can be made without departing from the scope of the present invention.

What is claimed is:

1. A material for manufacturing pet toys comprising:
a mesh material comprising one or more openings; and
at least one integrally formed molded projection extending outward from the mesh material.

2. The material of claim 1, wherein an outer surface surrounding the at least one integrally formed molded projection is course

3. The material of claim 1, wherein the mesh material comprises a cotton duck fabric.

4. The material of claim 3, wherein the cotton duck fabric has a weight of at least 10 oz and a thickness of 0.35 mm to 0.60 mm.

5. The material of claim 1, wherein the mesh material comprises a nylon fabric.

6. The material of claim 5, wherein the nylon fabric is a 420 denier fabric with a thickness of at least 0.20 mm.

7. A pet toy comprising:
a first material comprising:
a mesh material comprising one or more openings, and
at least one integrally formed molded projection extending outward from the mesh material; and
a second material attached to the first material, the second material having greater rigidity than the first material,
wherein the second material is overmolded onto at least a portion of the first material.

8. The pet toy of claim 7, wherein the second material is formed over all outer edges of the first material such that the outer edges of the first material are fully covered by the second material.

9. The pet toy of claim 7, wherein the mesh material comprises a cotton duck fabric.

10. The pet toy of claim 9, wherein the cotton duck fabric has a weight of at least 10 oz and a thickness of 0.35 mm to 0.60 mm.

11. The pet toy of claim 7, wherein the mesh material comprises a nylon fabric.

12. The material of claim 11, wherein the nylon fabric is a 420 denier fabric with a thickness of at least 0.20 mm.

13. The pet toy of claim 7, wherein the first material is at least partially collapsible.

14. The pet toy of claim 7, wherein the first material comprises a coarse outer surface surrounding the at least one integrally formed projection.

15. The pet toy of claim 7, wherein the first material and the second material cooperate to define an inner chamber of the pet toy.

16. The pet toy of claim 15, further comprising a sound-emitting device disposed inside the inner chamber.

17. A method of manufacturing a pet toy, the method comprising:
forming a first material comprising:
a mesh material comprising one or more openings, and
at least one integrally formed molded projection extending outward from the mesh material; and
overmolding a second material onto at least a portion of the first material, the second material having greater rigidity than the first material,
wherein the second material is formed over all outer edges of the first material such that the outer edges of the first material are fully covered by the second material.

18. The method of claim 17, wherein the mesh material is a cotton duck fabric having a weight of at least 10 oz and a thickness of 0.35 mm to 0.60 mm.

19. The method of claim 17, wherein the mesh material is a nylon fabric having at least 420 denier and a thickness of at least 0.20 mm.

20. The method of claim 17, wherein the first material and the second material cooperate to define an inner chamber of the pet toy.
